(19) United States
(12) Patent Application Publication
(10) Pub. No.: US 2026/0089395 A1
(43) Pub. Date: Mar. 26, 2026

(54) IMAGING DEVICE AND DISTANCE MEASURING DEVICE

(71) Applicant: Panasonic Intellectual Property Management Co., Ltd., Osaka (JP)

(72) Inventors: MAYU TABA, Osaka (JP); MASAHARU FUKAKUSA, Kumamoto (JP)

(21) Appl. No.: 19/111,336

(22) PCT Filed: Aug. 31, 2023
(86) PCT No.: PCT/JP2023/031729

§ 371 Date: Mar. 13, 2025

(30) Foreign Application Priority Data
Oct. 25, 2022 (JP) 2022-170941

(51) Int. Cl. H04N 23/695; G01C 3/14; G06T 7/593

(52) U.S. Cl. CPC H04N 23/695; G01C 3/14; G06T 7/593

(57) ABSTRACT

An imaging unit includes an imaging element, an imaging optical system that includes an off-axis parabolic mirror, and a driving mechanism. A reflective surface of the off-axis parabolic mirror is configured to face an object. The driving mechanism is configured to change positions of the imaging element and a part of the imaging optical system so as to change an imaging direction of the imaging unit while maintaining a position of a focal point of the off-axis parabolic mirror.

### TECHNICAL FIELD

The present disclosure relates to a distance measuring device so-called a stereo camera, and an imaging device used for, e.g., the distance measuring device.

### BACKGROUND ART

A distance measuring device, which is so-called a stereo camera, is used to measure various works on a conveyor belt three-dimensionally. In the stereo camera with a convergence angle, a distance resolution may be changed by changing the convergence angle.

PTL 1 discloses a configuration of a stereo camera equipped with a tilted camera and a plane mirror. This configuration has a mechanism configured to rotate the plane mirror about a geometric center to change the convergence angle.

### CITATION LIST

### Patent Literature

PTL 1: Japanese Patent Laid-Open Publication No. 2019-219553

### SUMMARY OF INVENTION

In the configuration disclosed in PTL 1, since the plane mirror rotates about the geometric center to change the convergence angle, the change of the convergence angle causes an imaging range of the stereo camera to largely shift. For this reason, after the convergence angle is changed, the camera is required to move to capture an image of an object, or additional image processing is required to search the object. This may cause a problem that it takes time for measurement.

An imaging device in accordance with an aspect of the present disclosure configured to capture an image of an object includes an imaging element, an imaging optical system, and a driving mechanism that is configured to change positions of the imaging element and a part of the imaging optical system. The imaging optical system includes at least an off-axis parabolic mirror. The driving mechanism is configured to change positions of the imaging element and the part of the imaging optical system so as to change an imaging direction while maintaining a focal position of the off-axis parabolic mirror.

The distance measuring device in accordance with another aspect of the present disclosure is configured to measure a distance to an object and includes a first imaging unit and a second imaging unit that are arranged such that optical axes of the first imaging unit and the second imaging unit intersect with each other at a convergence angle, and an image processor configured to calculate a distance to the object based on plural images of the object captured by the first imaging unit and the second imaging unit. Each of the first imaging unit and the second imaging unit includes an imaging element, an imaging optical system, and a driving mechanism that is configured to change positions of the imaging element and a part of the imaging optical system. The imaging optical system includes an off-axis parabolic mirror. The driving mechanism is configured to change positions of the imaging element and the part of the imaging optical system so as to change an imaging direction while maintaining a focal position of the off-axis parabolic mirror.

According to the present disclosure, the distance measuring device may change the convergence angle without shifting an imaging range. Thus, a distance resolution can easily be changed, thereby reducing a time required for measurement.

### BRIEF DESCRIPTION OF DRAWINGS

FIG. 1 is a schematic view of a main part of a distance measuring device in accordance with a first exemplary embodiment relating to imaging.

FIG. 2A is a schematic view of an on-axis parabolic mirror.

FIG. 2B is a schematic view of an off-axis parabolic mirror.

FIG. 3A illustrates a mechanism of the distance measuring device in accordance with the first embodiment.

FIG. 3B illustrates the mechanism of the distance measuring device in accordance with the first embodiment.

FIG. 4A illustrates the distance measuring device in accordance with the first embodiment with a large convergence angle.

FIG. 4B illustrates the distance measuring device in accordance with the first embodiment with a short convergence angle.

FIG. 5 illustrates the distance measuring device in accordance with the first embodiment.

FIG. 6 illustrates a measurement operation of the distance measuring device in accordance with the first embodiment.

FIG. 7A illustrates an advantageous effect of the distance measuring device in accordance with the first embodiment.

FIG. 7B illustrates the effect of the distance measuring device in accordance with the first embodiment.

FIG. 8 is a configuration diagram of main part of a distance measuring device in accordance with a second exemplary embodiment relating to imaging.

FIG. 9A illustrates a mechanism of the distance measuring device in accordance with the second embodiment.

FIG. 9B illustrates the mechanism of the distance measuring device in accordance with the second embodiment.

FIG. 10A illustrates the distance measuring device in accordance with the second embodiment with a large convergence angle is large.

FIG. 10B illustrates the distance measuring device in accordance with the second embodiment with a small convergence angle.

### DESCRIPTION OF EMBODIMENT

### Outline

The imaging device in accordance with an aspect of the present disclosure is configured to capture an image of an object, and includes an imaging element, an imaging optical system, and a driving mechanism configured to change positions of the imaging element and a part of the imaging optical system. The imaging optical system includes an off-axis parabolic mirror. The driving mechanism is configured to change the positions of the imaging element and the part of the imaging optical system so as to change an imaging direction of the imaging device while maintaining a position of a focal point of the off-axis parabolic mirror.

According to this configuration, the imaging device includes the off-axis parabolic mirror of the imaging optical system. The imaging device includes the driving mechanism configured to change positions of the imaging element and a part of the imaging optical system. The driving mechanism is configured to change positions of the imaging element and the part of the imaging optical system so as to change an imaging direction of the imaging device while maintaining a position of a focal point of the off-axis parabolic mirror. Thus, even if not being moved, the imaging device may change the imaging direction while maintaining the imaging range.

In the imaging device in accordance with the above-mentioned aspect, a position of the off-axis parabolic mirror may be fixed. The driving mechanism may be configured to change positions of the imaging element and the optical member so as to change a position of an area on a reflective surface of the off-axis parabolic mirror corresponding to an imaging range of the imaging element. That is, the imaging optical system may further include an optical member configured to guide, to the imaging element, light coming from the object and reflecting on the off-axis parabolic mirror. In this case, the driving mechanism may change positions of the imaging element and the optical member of the imaging optical system other than the off-axis parabolic mirror so as to change a position of an area on a reflective surface of the off-axis parabolic mirror corresponding to an imaging range of the imaging element.

Through the operation of the driving mechanism, the imaging device can change a position of the area on the reflective surface of the off-axis parabolic mirror corresponding to the imaging range of the imaging element. This changes the imaging direction while maintaining the imaging range.

In the imaging device in accordance with the above-mentioned aspect, the driving mechanism may be configured to rotationally move the off-axis parabolic mirror about a focal point of the off-axis parabolic mirror with a radius of a focal length of the off-axis parabolic mirror.

Through the operation of the driving mechanism, the imaging device can rotationally move the off-axis parabolic mirror while maintaining the focal position. This may change the imaging direction while maintaining the imaging range.

The distance measuring device in accordance with an aspect of the present disclosure is configured to measure a distance to an object, and includes: a first imaging unit and a second imaging unit arranged such that optical axes of the first imaging unit and the second imaging unit intersect with each other at a convergence angle; and an image processor configured to calculate a distance to the object based on plural images of the object captured by the first imaging unit and the second imaging unit. Each of the first imaging unit and the second imaging unit includes an imaging element, an imaging optical system, and a driving mechanism configured to change positions of the imaging element and a part of the imaging optical system. The imaging optical system includes an off-axis parabolic mirror. The driving mechanism is configured to change the positions of the imaging element and the part of the imaging optical system so as to change an imaging direction of the each of the first imaging unit and the second imaging unit while maintaining a position of a focal point of the off-axis parabolic mirror.

According to this configuration, the distance measuring device is configured to measure a distance to an object, and includes: the first imaging unit and the second imaging unit arranged such that optical axes of the first imaging unit and the second imaging unit intersect with each other at the convergence angle; and the image processor configured to calculate the distance to the object based on the plural images of the object captured by the first imaging unit and the second imaging unit. Each of the first imaging unit and the second imaging unit includes the driving mechanism configured to change positions of the imaging element and the part of the imaging optical system. The driving mechanism is configured to change the positions of the imaging element and the part of the imaging optical system so as to change the imaging direction while maintaining a position of a focal point of the off-axis parabolic mirror. Thus, the first imaging unit and the second imaging unit can change the imaging direction while maintaining the imaging range. Therefore, the distance measuring device can change the convergence angle without shifting the imaging range. This configuration may readily change a distance resolution, thereby reducing the time required for measurement.

In the distance measuring device in accordance with the above-mentioned aspect, the imaging optical system of the each of the first imaging unit and the second imaging unit may further include an optical member configured to guide, to the imaging element, light coming from the object and reflecting on the off-axis parabolic mirror. A position of the off-axis parabolic mirror may be fixed. The driving mechanism may be configured to change the positions of the imaging element and the optical member so as to change a position of an area on a reflective surface of the off-axis parabolic mirror corresponding to an imaging range of the imaging element.

Through the operation of the driving mechanism, each of the first imaging unit and the second imaging unit can change a position of the area on the reflective surface of the off-axis parabolic mirror corresponding to the imaging range of the imaging element. This may change the imaging direction while maintaining the imaging range.

Further, in the distance measuring device in accordance with the above-mentioned aspect, the driving mechanism of the each of the first imaging unit and the second imaging unit may be configured to rotationally move the off-axis parabolic mirror about a focal point of the off-axis parabolic mirror with a radius of a focal length of the off-axis parabolic mirror.

Through the operation of the driving mechanism, each of the first imaging unit and the second imaging unit can rotationally move the off-axis parabolic mirror while maintaining the focal position. This configuration may change the imaging direction while maintaining the imaging range.

Further, in the distance measuring device in accordance with the above-mentioned aspect, when changing the convergence angle, the image processor may be configured to: provide the each of the first imaging unit and the second imaging unit with amounts of change in the positions changed by the driving mechanism; and calculate a new convergence angle based on the amounts of change that is instructed.

When the convergence angle is changed, the image processor can calculate a new convergence angle based on the amounts of changes in the positions changed by the driving mechanisms, the first imaging unit and the second imaging unit are provided with the amounts.

### Exemplary Embodiments

Exemplary embodiments will be described below with reference to the drawings.

Note that, each exemplary embodiment described below shows a comprehensive or concrete example. The numerical values, shapes, materials, structural elements, the arrangement and connection of the structural elements, steps, the processing order of the steps or the like, shown in the following exemplary embodiment are mere examples, and are therefore not intended to limit the present disclosure. Further, among elements in the following exemplary embodiments, those not recited in any of the independent claims defining the most generic part of the inventive concept are described as optional elements.

### First Exemplary Embodiment

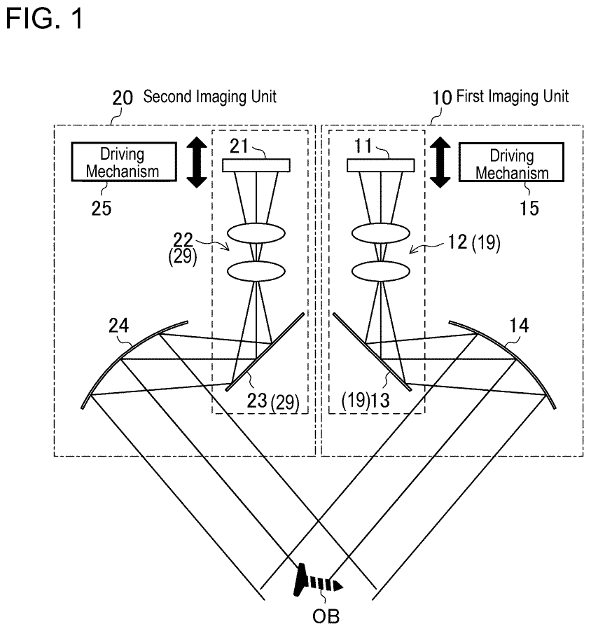

FIG. 1 illustrates a main part of a distance measuring device in accordance with a first exemplary embodiment relating to imaging. The distance measuring device in accordance with the embodiment includes first imaging unit 10 and second imaging unit 20 that have common structures. First imaging unit 10 and second imaging unit 20 may be implemented separately by individual imaging devices.

First imaging unit 10 includes imaging element 11, image-forming optical system 12, plane mirror 13, and off-axis parabolic mirror 14. Image-forming optical system 12, plane mirror 13, and off-axis parabolic mirror 14 constitute an imaging optical system. In first imaging unit 10, imaging element 11 is configured to capture an image of object OB through the imaging optical system. Image-forming optical system 12 is one of one or more optical members 19 configured to guide,, to imaging element 11, light which comes from object OB and reflects on off-axis parabolic mirror 14. Plane mirror 13 is one of one or more optical members 19 configured to guide, to imaging element 11, the light which comes from object OB and reflects on off-axis parabolic mirror 14.

Second imaging unit 20 includes imaging element 21, image-forming optical system 22, plane mirror 23, and off-axis parabolic mirror 24. Image-forming optical system 22, plane mirror 23, and off-axis parabolic mirror 24 constitute an imaging optical system. In second imaging unit 20, imaging element 21 is configured to capture an image of object OB through the imaging optical system. Image-forming optical system 22 is one of one or more optical members 29 configured to guide, to imaging element 11, light which comes from object OB and reflects on off-axis parabolic mirror 24. Plane mirror 23 is one of one or more optical members 29 configured to guide, to imaging element 11, the light which comes from object OB and reflects on off-axis parabolic mirror 24.

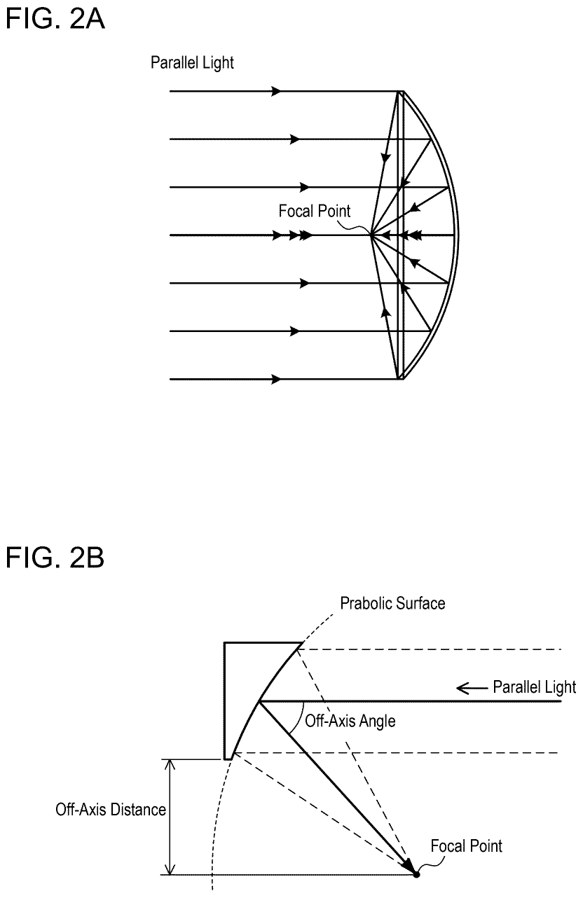

The off-axis parabolic mirror will be described below with referring to FIGS. 2A and 2B. FIG. 2A is a cross-sectional view of an on-axis parabolic mirror. As shown in FIG. 2A, the on-axis parabolic mirror is configured to allow incident parallel light to converge on a focal point of the mirror even when reflecting on any portion of a paraboloidal surface of the mirror. FIG. 2B is a cross-sectional view of the off-axis parabolic mirror. As shown in FIG. 2B, the off-axis parabolic mirror has the same function as the on-axis parabolic mirror, and is constituted by a portion of an on-axis mirror off the axis the on-axis mirror. In other words, the off-axis parabolic mirror is configured to also allow incident parallel light to converge on a focal point of the mirror even when reflecting on any portion of a paraboloidal surface of the mirror.

As shown in FIG. 1, in accordance with the embodiment, first imaging unit 10 includes driving mechanism 15 configured to vertically move positions of imaging element 11, image-forming optical system 12, and plane mirror 13. For instance, driving mechanism 15 may include a member supporting imaging element 11, image-forming optical system 12, and plane mirror 13, and a mechanism configured to translate the member with a small actuator, such as a motor. A relative positional relation of imaging element 11, image-forming optical system 12, and plane mirror 13 does not change. The position of off-axis parabolic mirror 14 is fixed. Similarly, second imaging unit 20 includes driving mechanism 25 configured to vertically move positions of imaging element 21, image-forming optical system 22, and plane mirror 23. The same structure as driving mechanism 15 may be used to constitute driving mechanism 25. The position of off-axis parabolic mirror 24 is fixed. Through the operation of the driving mechanisms, first imaging unit 10 and second imaging unit 20 can change imaging directions thereof while maintaining, i.e., fixing focal positions of off-axis parabolic mirrors 14 and 24.

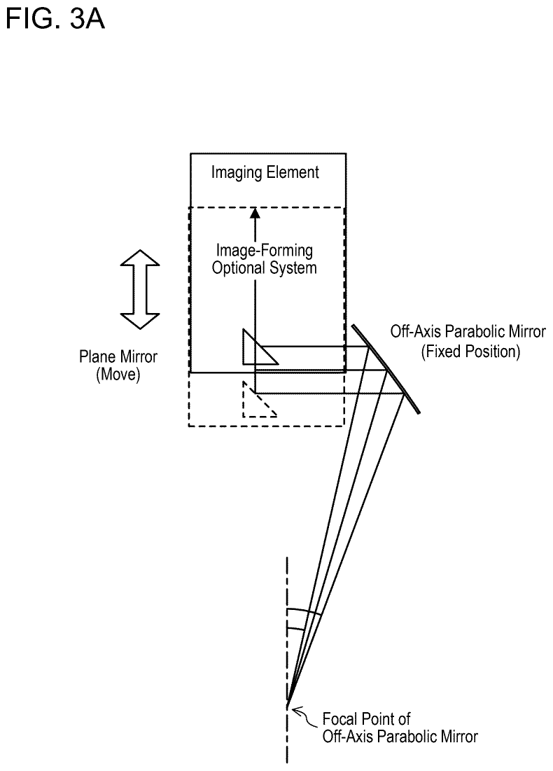

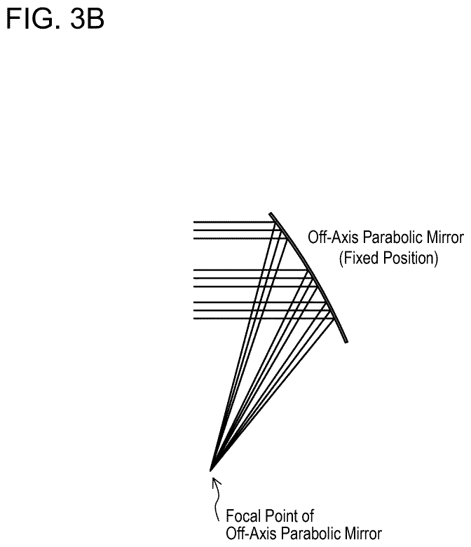

The mechanisms in accordance with the embodiment will be described below with referring to FIGS. 3A and 3B. As shown in FIG. 3A, in accordance with the embodiment, the driving mechanism is configured to vertically move the imaging element, the image-forming optical system, and the plane mirror while fixing a position of the off-axis parabolic mirror, as mentioned above. This operation changes a position of an area on a reflective surface of the off-axis parabolic mirror corresponding to an imaging range of the imaging element, as shown in FIG. 3B. For instance, when the imaging element, the image-forming optical system, and the plane mirror are moved upward, an area on an upper side of the reflective surface of the off-axis parabolic mirror is imaged. On the other hand, when the imaging element, the image-forming optical system, and the plane mirror are moved downward, an area on a lower side of the reflective surface of the off-axis parabolic mirror is imaged. In other words, the driving mechanism is configured to change an imaging direction of the imaging unit. The focal position of the off-axis parabolic mirror does not change.

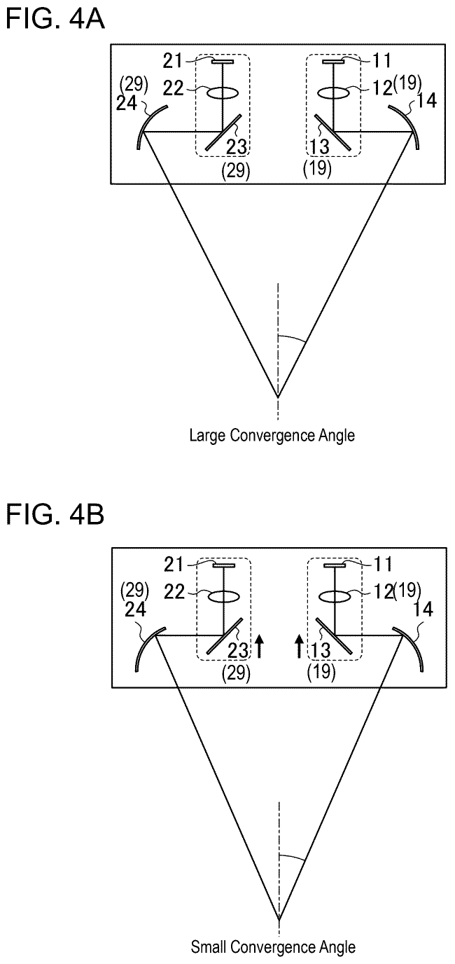

In accordance with the present embodiment, first imaging unit 10 and second imaging unit 20 operate driving mechanisms 15 and 25 to change the imaging directions, thereby changing a convergence angle of the distance measuring device. In other words, in FIG. 4A, positions of imaging element 11, image-forming optical system 12, and plane mirror 13 are moved downward. In addition to this, positions of imaging element 21, image-forming optical system 22, and plane mirror 23 are moved downward. These movements increase the convergence angle of the distance measuring device. On the other hand, in FIG. 4B, positions of imaging element 11, image-forming optical system 12, and plane mirror 13 are moved upward. In addition to this, positions of imaging element 21, image-forming optical system 22, and plane mirror 23 are moved upward. These movements decrease the convergence angle of the distance measuring device.

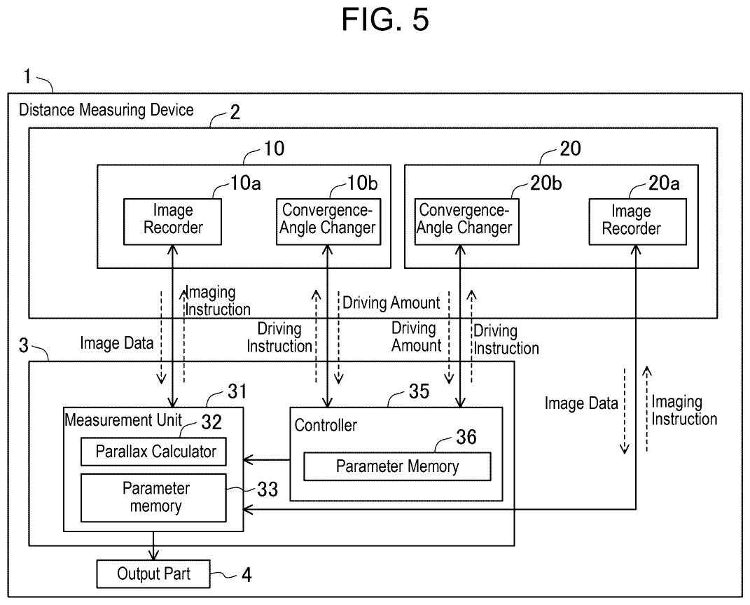

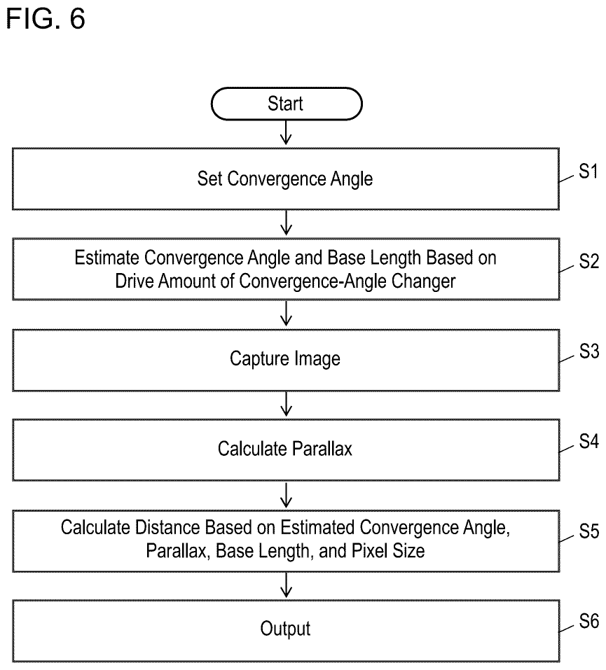

FIG. 5 is a block diagram of the distance measuring device in accordance with the present embodiment. FIG. 6 is a flowchart exemplarily showing a measurement operation of the distance measuring device in accordance with the embodiment.

As shown in FIG. 5, distance measuring device 1 includes image acquisition section 2, image processor 3, and output part 4. Image acquisition section 1 includes first imaging unit 10 and second imaging unit 20, which are mentioned above. First imaging unit 10 includes image recorder 10a and convergence-angle changer 10b configured to change the convergence angle. Image recorder 10a includes imaging element 11 and an imaging optical system that includes image-forming optical system 12, plane mirror 13, and off-axis parabolic mirror 14. Convergence-angle changer 10b includes driving mechanism 15. Second imaging unit 20 includes image recorder 20a and convergence-angle changer 20b configured to change the convergence angle. Image recorder 20a includes imaging element 21 and an imaging optical system that includes image-forming optical system 22, plane mirror 23, and off-axis parabolic mirror 24. Convergence-angle changer 20b includes driving mechanism 25.

Image processor 3 includes measurement unit 31 and controller 35. Controller 35 transmits a drive instruction to convergence-angle changers 10b and 20b when the convergence angle is changed. Convergence-angle changer 10b which has received the drive instruction changes positions of imaging element 11, image-forming optical system 12, and plane mirror 13 through the drive operation, and transmits, to controller 35, data which indicates a drive amount. Similarly, convergence-angle changer 20b which has received the drive instruction changes positions of imaging element 21, image-forming optical system 22, and plane mirror 23 through the drive operation, and transmits, to controller 35, data which indicates a drive amount.

In controller 35, parameter calculator 36 calculates a convergence angle based on the drive amounts, and transmits the calculated convergence angle to parameter memory 33 of measurement unit 31. For instance, parameter calculator 36 previously prepares a relationship between a drive amount and a convergence angle, and estimates the convergence angle based on the transmitted drive amount with reference to this relationship. Image processor 3 may provide first imaging unit 10 and second imaging unit 20 with amounts of changes in position changed by driving mechanisms 15 and 25, and calculate a new convergence angle based on the amounts of changes.

In measurement unit 31, parameter memory 33 stores information including, e.g., a base length, a pixel size, and a focal length in addition to the convergence angle. Measurement unit 31 transmits an imaging direction to image recorders 10a and 20a, and receives image data obtained by capturing. Parallax calculator 32 calculates a parallax based on the received image data. Based on the calculated parallax and the information stored in parameter memory 33, measurement unit 31 calculates distance information of the object, and transmits it to output part 4.

In an example of measurement operation shown in FIG. 6, convergence-angle changers 10b and 20b perform drive operation so as to obtain a set convergence angle (S1). Convergence-angle changers 10b and 20b transmit a drive amount to controller 35, and parameter calculator 36 estimates a convergence angle and a base length based on the drive amount (S2). Image recorders 10a and 20a capture images, and transmit image data obtained by the capturing to measurement unit 31 (S3). Parallax calculator 32 calculates a parallax based on the image data (S4). Measurement unit 31 calculates the distance based on the convergence angle calculated by parameter calculator 36, the parallax calculated by parallax calculator 32, and information on the base length calculated by parameter memory 33 and the pixel size stored in parameter memory 33 (S5). A result of the distance calculation is transmitted to output part 4 (S6).

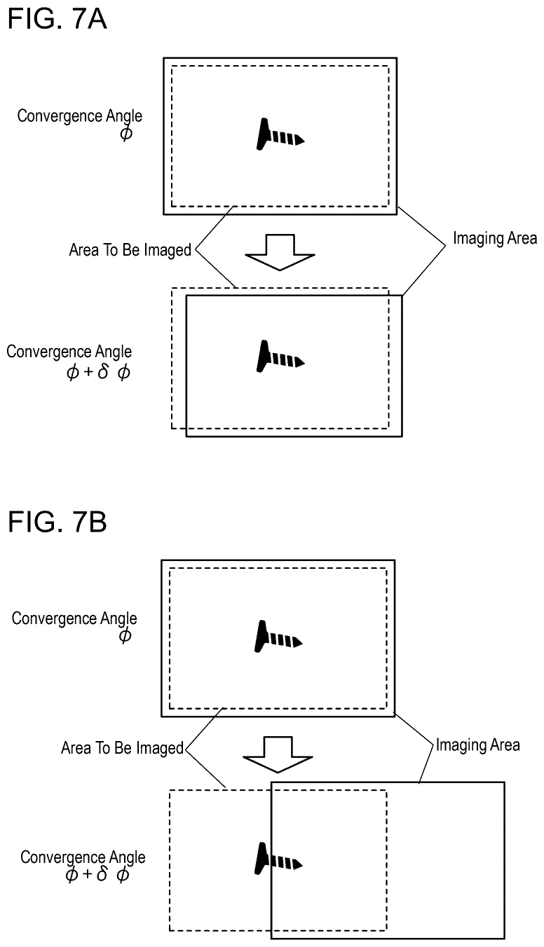

FIGS. 7A and 7B illustrate an effect of the present exemplary embodiment. In accordance with the present embodiment, even if the convergence angle is changed, a focal position of the off-axis parabolic mirror is maintained, as shown in FIG. 7A. In other words, the imaging range is almost unchanged, and a position of the measurement target is almost unchanged in the captured image. On the other hand, in the conventional configuration in which a plane mirror is rotated to change a convergence angle, the imaging range is changed largely with the convergence angle changes, as shown in FIG. 7B. As a result, the measurement target does not appear in the captured image or only a part of the measurement target appears therein. Alternatively, even if the measurement target appears in the captured image, the position is largely changed. Therefore, to capture the image, image processing for searching for the measurement target is required, or a camera needs to be moved according to a position of the measurement target. On the other hand, in accordance with the present embodiment, a position of the measurement target is almost unchanged in the captured image before and after the convergence angle is changed. Therefore, additional image processing is not necessary.

As mentioned above, distance measuring device 1 according to the present exemplary embodiment is configured to measure a distance to an object, and includes first imaging unit 10 and second imaging unit 20 that are arranged such that optical axes of first imaging unit 10 and second imaging unit 20 intersect with each other at a convergence angle. First imaging unit 10 and second imaging unit 20 include off-axis parabolic mirror 14 and off-axis parabolic mirror 24 in the imaging optical system, respectively. Reflective surfaces of off-axis parabolic mirror 14 and off-axis parabolic mirror 24 are directed to face object OB, a distance measurement target. First imaging unit 10 includes driving mechanism 15 configured to vertically move imaging element 11, image-forming optical system 12, and plane mirror 13. Second imaging unit 20 includes driving mechanism 25 configured to vertically move imaging element 21, image-forming optical system 22, and plane mirrors 23. Driving mechanism 15 is driven to change a position of an area on a reflective surface of off-axis parabolic mirror 14 corresponding to an imaging range of imaging element 11. Driving mechanism 25 is driven to change a position of an area on a reflective surface of off-axis parabolic mirror 24 corresponding to an imaging range of imaging element 21. First imaging unit 10 and second imaging unit 20 can change their imaging directions while maintaining the imaging range. Therefore, distance measuring device 1 can change the convergence angle without sifting the imaging range. Consequently, a distance resolution can easily be changed, thereby reducing the time required for measurement.

In accordance with the present embodiment, the driving mechanism is configured to vertically move the imaging element, the image-forming optical system, and the plane mirror, but another configuration may be employed as long as the position of the area on the reflective surface of the off-axis parabolic mirror corresponding to the imaging range of the imaging element can be changed. For instance, the plane mirror may be eliminated, i.e., the imaging element and the image-forming optical system is arranged side by side in a lateral direction of the off-axis parabolic mirror. The imaging element and the image-forming optical system may be moved vertically by the driving mechanism.

### Second Exemplary Embodiment

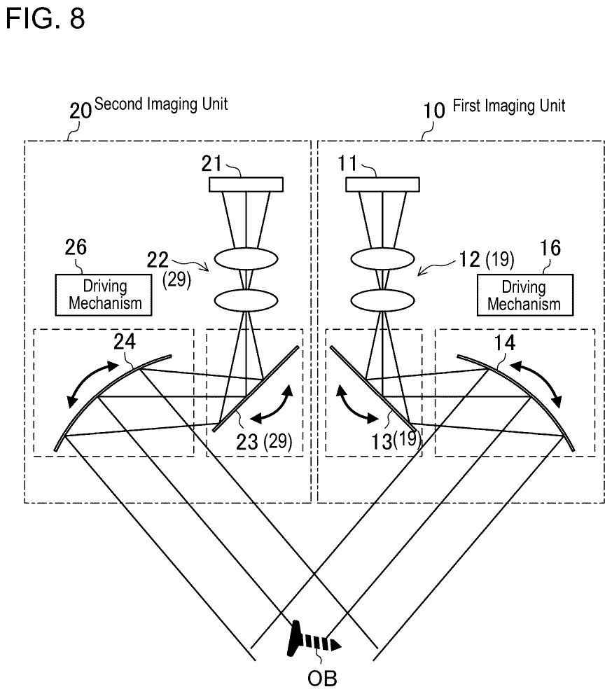

FIG. 8 illustrates a main part of a distance measuring device in accordance with a second exemplary embodiment relating to imaging. The distance measuring device in accordance with the present embodiment includes first imaging unit 10 and second imaging unit 20 that have common structure, similarly to the first embodiment. First imaging unit 10 and second imaging unit 20 may be implemented separately by individual imaging devices.

Components of first imaging unit 10 and second imaging unit 20 are substantially the same as those of the first embodiment. In other words, first imaging unit 10 includes imaging element 11, image-forming optical system 12, plane mirror 13, and off-axis parabolic mirror 14. Second imaging unit 20 includes imaging element 21, image-forming optical system 22, plane mirror 23, and off-axis parabolic mirror 24.

In accordance with the present embodiment, first imaging unit 10 includes driving mechanism 16 configured to rotationally move off-axis parabolic mirror 14 while rotating plane mirror 13 according to the rotation of off-axis parabolic mirror 14. For instance, driving mechanism 16 may be configured to rotationally move off-axis parabolic mirror 14 and plane mirror 13 individually with small actuators such as motors. Positions of imaging element 11 and image-forming optical system 12 are fixed. Similarly, second imaging unit 20 includes driving mechanism 26 configured to rotationally move off-axis parabolic mirror 24 while rotating plane mirror 23 according to the rotation of off-axis parabolic mirror 24. For instance, driving mechanism 26 may be configured to rotationally move off-axis parabolic mirror 24 and plane mirror 23 individually with small actuators, such as motors. Positions of imaging element 21 and image-forming optical system 22 are fixed.

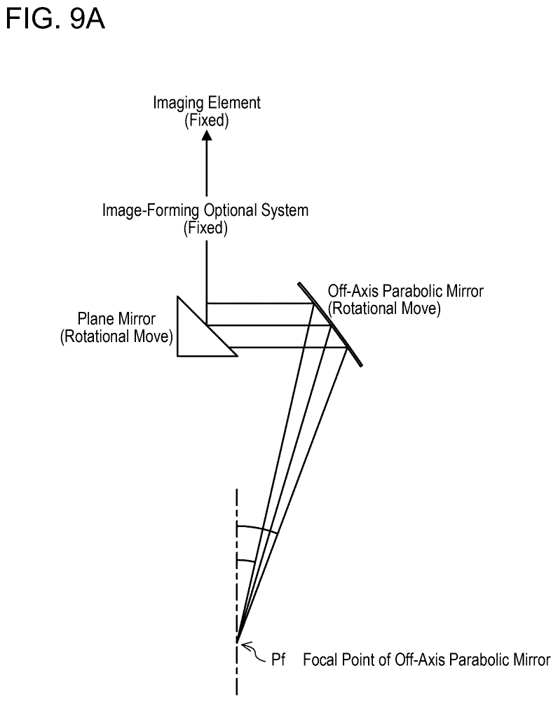

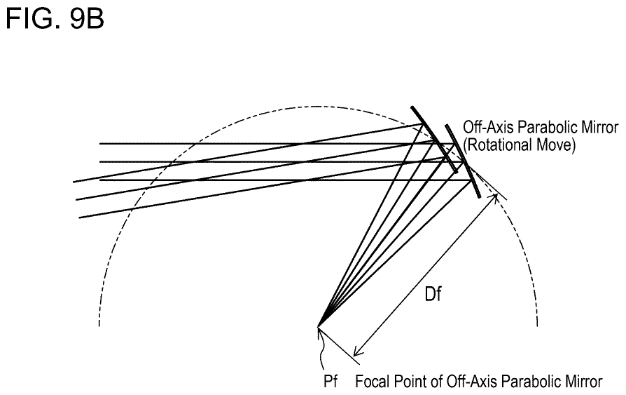

A mechanism in accordance with the exemplary embodiment will be described with referring to FIGS. 9A and 9B. As mentioned above, in accordance with the present embodiment, the off-axis parabolic mirror rotationally moves, and the plane mirror rotationally moves according to the rotationally movement while positions of the imaging element and the image-forming optical system are fixed, as shown in FIG. 9A. As shown in FIG. 9B, the off-axis parabolic mirror rotationally moves with a radius of focal length Df of the off-axis parabolic mirror while a position of focal point Pf of the off-axis parabolic mirror is maintained. The plane mirror rotationally moves such that an imaging range of the imaging element is held on a reflective surface of the off-axis parabolic mirror. This operation of the driving mechanism prevents an imaging direction of the imaging unit from changing. The position of focal point Pf of the off-axis parabolic mirror is unchanged.

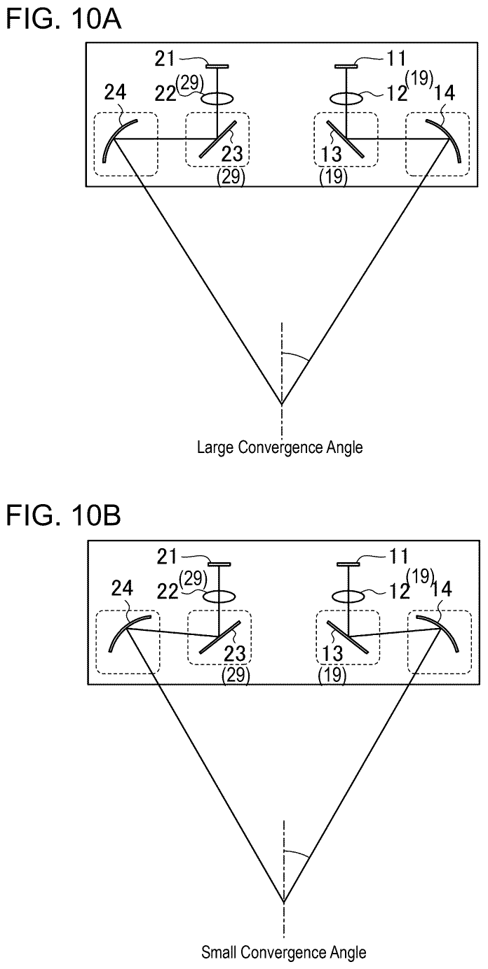

In accordance with the present embodiment, driving mechanisms 16 and 26 are configured to change imaging directions of first imaging unit 10 and second imaging unit 20, thereby changing the convergence angle pf the distance measuring device. In other words, in FIG. 10A, off-axis parabolic mirrors 14 and 24 rotationally move obliquely downward in the drawing. This changes the imaging direction slightly upward. This change increases the convergence angle of the distance measuring device. On the other hand, in FIG. 10B, off-axis parabolic mirrors 14 and 24 rotationally move obliquely upward in the drawing. This changes the imaging direction slightly downward. This change decreases the convergence angle of the distance measuring device.

A configuration example of the distance measuring device in accordance with the present embodiment is the same as that of FIG. 5. In accordance with the present embodiment, convergence-angle changer 10b includes driving mechanism 16. Convergence-angle changer 20b includes driving mechanism 26. Convergence-angle changer 10b which has received a drive instruction rotationally moves off-axis parabolic mirror 14 and plane mirror 13 by drive operation of driving mechanism 16, and transmits data indicating a drive amount to controller 35. Similarly, convergence-angle changer 20b which has received a drive instruction rotationally moves off-axis parabolic mirror 24 and plane mirror 23 by drive operation of driving mechanism 26, and transmits data indicating a drive amount to controller 35. In controller 35, parameter calculator 36 calculates a convergence angle based on the drive amounts, and transmits the calculated convergence angle to parameter memory 33 of measurement unit 31. For instance, parameter calculator 36 previously prepares a relationship between a drive amount and a convergence angle, and estimates a convergence angle based on the transmitted drive amounts with referring to this relationship. The other configurations and operations are the same as those of the first embodiment, and detailed description thereof is omitted.

The present exemplary embodiment provides the same effect as the first embodiment. In other words, in accordance with the present embodiment, a focal position of the off-axis parabolic mirror is maintained even if a convergence angle is changed, as shown in FIG. 7A. Therefore, the imaging range is almost unchanged, and a position of the measurement target is almost unchanged in the captured image.

As mentioned above, distance measuring device 1 according to the present exemplary embodiment is configured to measure a distance to an object, and includes first imaging unit 10 and second imaging unit 20 that are arranged such that optical axes of first imaging unit 10 and second imaging unit 20 intersect with each other at a convergence angle. First imaging unit 10 and second imaging unit 20 include off-axis parabolic mirrors 14 and 24 in the imaging optical system, respectively. Reflective surfaces of off-axis parabolic mirrors 14 and 24 are directed to face object OB, as a distance measurement target. First and imaging units 10 and 20 include driving mechanisms 16 and 26 configured to rotationally move off-axis parabolic mirrors 14 and 24 while maintaining the focal position of the mirrors, respectively. First imaging unit 10 and second imaging unit 20 can change an imaging direction by drive operation of driving mechanisms 16 and 26 while maintaining an imaging range. Therefore, distance measuring device 1 can change a convergence angle without sifting the imaging range. Consequently, a distance resolution can easily be changed, thereby reducing the time required for measurement.

In accordance with the present disclosure, the driving mechanisms of the first imaging unit and the second imaging unit are not limited to the configuration shown in the above embodiments. In other words, the other configuration may be employed as long as positions of the imaging element and a part of the imaging optical system are changed such that an imaging direction is changed while a focal position of the off-axis parabolic mirror is maintained.

The off-axis parabolic mirror in accordance with the above embodiments will be additionally described below. The off-axis parabolic mirror preferably has a paraboloidal surface, but may have a surface defined by high-order aspheric coefficients to, e.g., correct aberrations. The entirety of the surface of the mirror may not necessarily be paraboloidal. At least a portion of the surface of the mirror corresponding to an imaging range of the imaging element may be a paraboloidal surface.

In accordance with the above embodiments, a relationship between a drive amount and a convergence angle is previously prepared to estimate a convergence angle. Instead, the following method may be employed, i.e., a mechanism (e.g., a projector) configured to project a pattern on an object is provided at the time of measurement. A certain pattern is projected on an imaging area, and distortion of the pattern image, is captured, and is analyzed with image processing. The convergence angle may be estimated based on a degree of the distortion.

Depending on the shape of the object, a convergence angle may be changed and adjusted. In other words, for the object with a fine structure, the convergence angle is increased. The base length increases as the convergence angle increases, thereby enhancing distance resolution. The amount of change in the convergence angle is set by a user, or the convergence angle may be changed gradually.

To determine fineness of the object, image processing may preferably be applied to an image. For instance, a Fourier image of the image, the number of edges of the image, or a rate of change in brightness of a certain area is employed to determine the fineness of structure. Alternatively, a user may determine fineness of structure and instruct the device to change the convergence angle.

Further, configurations of the first imaging unit and the second imaging unit of the distance measuring device in accordance with the above embodiments can be individual imaging devices. In this imaging device, even if not being moved, the imaging device can change an imaging direction while maintaining the imaging range. The imaging device in accordance with the present disclosure is also usable for the other applications other than the distance measuring device.

### INDUSTRIAL APPLICABILITY

A distance measuring device in accordance with the present disclosure can change a distance resolution easily. Therefore, it is useful to reduce a time required for measuring three-dimensional shapes of various workpieces, for example.

### REFERENCE MARKS IN THE DRAWINGS

1 distance measuring device
2 image acquisition section
3 image processor
10 first imaging unit
11 imaging element
12 coupled optical system
13 plane mirror
14 off-axis parabolic mirror
15 driving mechanism
16 driving mechanism
19 optical member
20 second imaging unit
21 imaging element
22 coupled optical system
23 plane mirror
24 off-axis parabolic mirror
25 driving mechanism
26 driving mechanism
29 optical member
OB object

1. An imaging device configured to capture an image of an object, the imaging device comprising:
an imaging element;
an imaging optical system; and
a driving mechanism configured to change positions of the imaging element and a part of the imaging optical system, wherein
the imaging optical system includes an off-axis parabolic mirror, and
the driving mechanism is configured to change the positions of the imaging element and the part of the imaging optical system so as to change an imaging direction of the imaging device while maintaining a position of a focal point of the off-axis parabolic mirror.

2. The imaging device according to claim 1, wherein
the imaging optical system further includes an optical member configured to guide, to the imaging element, light coming from the object and reflecting on the off-axis parabolic mirror,
a position of the off-axis parabolic mirror is fixed; and
the driving mechanism is configured to change positions of the imaging element and the optical member so as to change a position of an area on a reflective surface of the off-axis parabolic mirror corresponding to an imaging range of the imaging element.

3. The imaging device according to claim 1, wherein the driving mechanism is configured to rotationally move the off-axis parabolic mirror about a focal point of the off-axis parabolic mirror with a radius of a focal length of the off-axis parabolic mirror.

4. A distance measuring device configured to measure a distance to an object, the distance measuring device comprising:
a first imaging unit and a second imaging unit arranged such that optical axes of the first imaging unit and the second imaging unit intersect with each other at a convergence angle; and
an image processor configured to calculate a distance to the object based on plural images of the object captured by the first imaging unit and the second imaging unit, wherein
each of the first imaging unit and the second imaging unit includes:
an imaging element:
an imaging optical system; and
a driving mechanism configured to change positions of the imaging element and a part of the imaging optical system,
the imaging optical system includes an off-axis parabolic mirror, and
the driving mechanism is configured to change the positions of the imaging element and the part of the imaging optical system so as to change an imaging direction of the each of the first imaging unit and the second imaging unit while maintaining a position of a focal point of the off-axis parabolic mirror.

5. The distance measuring device according to claim 4, wherein
the imaging optical system of the each of the first imaging unit and the second imaging unit further includes an optical member configured to guide, to the imaging element, light coming from the object and reflecting on the off-axis parabolic mirror,
a position of the off-axis parabolic mirror is fixed; and
the driving mechanism is configured to change the positions of the imaging element and the optical member so as to change a position of an area on a reflective surface of the off-axis parabolic mirror corresponding to an imaging range of the imaging element.

6. The distance measuring device according to claim 4, wherein the driving mechanism of the each of the first imaging unit and the second imaging unit is configured to rotationally move the off-axis parabolic mirror about a focal point of the off-axis parabolic mirror with a radius of a focal length of the off-axis parabolic mirror.

7. The distance measuring device according to claim 4, wherein, when changing the convergence angle, the image processor is configured to:
provide the each of the first imaging unit and the second imaging unit with amounts of change in the positions changed by the driving mechanism; and
calculate a new convergence angle based on the amounts of change that is instructed.
